(19) United States
(12) Patent Application Publication
(10) Pub. No.: US 2020/0080838 A1
(43) Pub. Date: Mar. 12, 2020

(54) APPARATUS AND METHOD FOR MEASURING THREE-DIMENSIONAL SHAPE

(71) Applicant: INTEKPLUS CO.,LTD., Daejeon (KR)

(72) Inventors: Sang Yoon LEE, Daejeon (KR); Min Gu KANG, Daejeon (KR); Hyun Min LEE, Daejeon (KR); Jai Ho SON, Gwangju (KR)

(73) Assignee: INTEKPLUS CO.,LTD., Daejeon (KR)

(21) Appl. No.: 16/469,681

(22) PCT Filed: Nov. 9, 2017
(86) PCT No.: PCT/KR2017/012695

§ 371 Date: Jun. 14, 2019

(30) Foreign Application Priority Data
Jan. 20, 2017 (KR) 10-2017-0009955

(51) Int. Cl. G01B 11/25

(52) U.S. Cl. CPC G01B 11/2518

(57) ABSTRACT

An apparatus for measuring a three-dimensional shape according to an embodiment of the present invention includes a measurement plane on which a measurement target is mounted, a light source configured to illuminate the measurement target, a lens configured to transmit light emitted from the light source, and an image acquisition means configured to capture an image reflected from a surface of the measurement target. The lens and the image acquisition means are arranged so that a focal region formed by the lens and the image acquisition means may coincide with a plane on which the light forms a shape.

### TECHNICAL FIELD

The present invention relates to an apparatus for measuring a three-dimensional shape, and more particularly, to a three-dimensional shape measuring apparatus for improving precision in measuring an examination target.

### BACKGROUND ART

In general, methods of measuring a three-dimensional shape are classified into a contact type of measuring the overall shape of a measurement target by measuring the measurement target one point by one point in a contact manner with a device for measuring a three-dimensional shape of a measurement target and a contactless type in which light is used.

Meanwhile, contactless measurement methods are generally classified into optical interferometry and optical triangulation.

Optical interferometry includes optical phase interferometry which is frequently used to measure a surficial shape of a semiconductor pattern or a fine mold with single-color light, such as laser, and optical scanning interferometry in which short coherence is used with white light. Optical interferometry makes precise measurement possible in nanometers (nm). However, it is difficult to rapidly measure a large area, and an expensive precise stage is required.

According to optical triangulation, determined certain light is projected to a measurement surface at any determined angle, and brightness of light changed at another angle according to a shape of the surface is extracted to interpret shape information of the surface. In optical triangulation, a laser pointer, a laser slit beam, or a moire pattern is used according to a projection method, and a measurement time is remarkably reduced compared to those of contact measurement methods.

According to a method in which a moire pattern is used, a straight glass lattice on one surface of which straight lines are carved with chrome at regular intervals is projected to a measurement target by using a projection optical system. Also, a straight glass lattice transfer device is used to transfer straight lines formed on the measurement target at regular intervals.

In the case of measuring a three-dimensional shape with a measurement device, when a light source and a lens are generally arranged and a three-dimensional shape is estimated by aggregating only images captured by an image acquisition means, the three-dimensional shape is distorted and differs from an actual shape.

### DISCLOSURE

### Technical Problem

The present invention is directed to providing a three-dimensional shape measuring apparatus and method for precisely and elaborately measuring a three-dimensional shape by forming a focal region perpendicular to a measurement plane.

### Technical Solution

One aspect of the present invention provides an apparatus for measuring a three-dimensional shape. The apparatus includes a measurement plane on which a measurement target is mounted, a light source configured to illuminate the measurement target, a lens configured to transmit light emitted from the light source, and an image acquisition means configured to capture an image reflected from a surface of the measurement target. The lens and the image acquisition means are arranged so that a focal region formed by the lens and the image acquisition means may coincide with a plane on which the light forms a shape.

The apparatus may further include a driving means configured to move the measurement plane on which the measurement target has been mounted in one direction.

Another aspect of the present invention provides a method of measuring a three-dimensional shape using an apparatus including a measurement plane on which a measurement target is mounted, a light source configured to illuminate the measurement target, a lens configured to transmit light emitted from the light source, and an image acquisition means configured to capture an image reflected from a surface of the measurement target. The method includes causing a focal region formed by the lens and the image acquisition means to coincide with a plane on which the light forms a shape and measuring the measurement target.

### Advantageous Effects

According to the present invention, it is possible to precisely and elaborately measure a three-dimensional shape.

### DESCRIPTION OF DRAWINGS

FIG. 1 is a perspective view of an apparatus for measuring a three-dimensional shape according to an embodiment of the present invention.

FIG. 2 is a perspective view of an apparatus for measuring a three-dimensional shape according to another embodiment of the present invention.

FIG. 3 is a flowchart of a method of measuring a three-dimensional shape using the three-dimensional shape measuring apparatus shown in FIG. 1.

### MODES OF THE INVENTION

Details of embodiments are included in detailed descriptions and drawings. Advantages and features of the disclosed technology and methods for achieving them will be made clear from embodiments described in detail below with reference to the drawings. Throughout the specification, like reference numerals refer to like elements.

The terms “first,” “second,” etc. may be used to describe various elements, but the elements are not limited by the terms. The terms are used only to distinguish one element from other elements. A singular form includes the plural form unless clearly indicated otherwise in the context. When a part is referred to as “including” an element, this indicates that the part may further include another element instead of excluding another element unless particularly stated otherwise. The terms “ . . . unit,” “module,” etc. used herein refer to a unit that performs at least one function or operation and may be implemented in hardware, software, or a combination thereof.

In a three-dimensional shape measuring apparatus 100 according to an embodiment of the present invention, a lens 140 and an image acquisition means 150 are arranged so that a focal region B formed by the lens 140 and the image acquisition means 150 may be perpendicular to a measurement plane 110. Therefore, it is possible to precisely measure a three-dimensional shape of a measurement target 10 disposed on the measurement plane 110.

In other words, when the measurement target 10 disposed on the measurement plane 110 is moved in one direction, the image acquisition means 150 may measure heights of the measurement target 10 on the basis of the measurement plane 110 and transmit the measured heights to a control unit 160, and the control unit 160 may show a three-dimensional shape of the measurement target 10 by aggregating the heights.

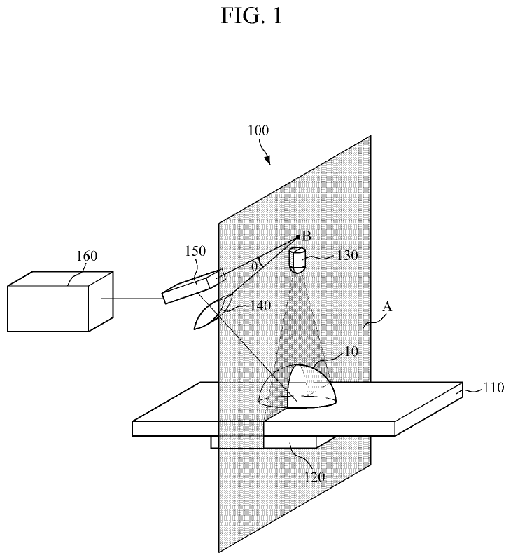

FIG. 1 is a perspective view of an apparatus for measuring a three-dimensional shape according to an embodiment of the present invention. Referring to FIG. 1, the three-dimensional shape measuring apparatus 100 according to an embodiment of the present invention includes the measurement plane 110, a driving means 120, a light source 130, the lens 140, the image acquisition means 150, and the control unit 160.

The measurement target 10 is mounted on the measurement plane 110. Here, the measurement plane 110 may move the measurement target 10 by the driving means 120. In other words, the measurement plane 110 may be moved in length and width directions by the driving means 120. Therefore, the measurement target 10 is moved with respect to the light source 130 and the image acquisition means 150, and thereby it is possible to scan heights of the measurement target 10 on the basis of the measurement plane 110 with respect to the entire area of the measurement target 10.

The driving means 120 is coupled to the measurement plane 110 and moves the measurement plane 110. The driving means 120 according to an embodiment of the present invention moves the measurement plane 110 in forward, backward, left, and right directions so that the image acquisition means 150 may measure the whole measurement target 10.

The light source 130 emits light to an upper surface of the measurement target 10. The light source 130 may include a laser light source 130 or a light-emitting diode (LED) light source 130. The light source 130 may be configured to emit light in the form of a line beam. The light source 130 emits light in the form of a slit to have a plane formed on the measurement target 10. The light emitted from the light source 130 is moved to illuminate the whole surface of the measurement target 10. Also, the light is incident on the lens 140.

The light source 130 may emit light perpendicularly to the measurement plane 110.

The lens 140 may be configured as a concave lens 140, a convex lens 140, or a combination thereof. The light emitted from the light source 130 is transmitted through the lens 140 and forms the focal region B.

The lens 140 according to an embodiment of the present invention includes an objective lens 140 or a collimating lens 140.

The image acquisition means 150 acquires an image of the measurement target 10 captured through the focal region formed by the lens 140 and the image acquisition means 150. The image acquisition means 150 may include a camera and an image sensor. The image sensor receives and converts an optical shape of an object into an electrical signal. The image sensor may be a charge-coupled device (CCD) image sensor, a complementary metal-oxide semiconductor (CMOS) image sensor, or the like. The image acquisition means 150 may include a line scan camera or an area scan camera.

The lens 140 according to an embodiment of the present invention may have a certain angle with respect to the image acquisition means 150. In particular, the lens 140 and the image acquisition means 150 have an angle θ therebetween so that the focal region B formed through light may coincide with a plane A on which the light forms a shape. In other words, the image acquisition means 150 is arranged so that the focal region B formed by the lens 140 and the image acquisition means 150 may coincide with the plane A on which the light forms a shape.

When the plane A on which the light forms a shape is moved by controlling the light source 130, the focal region B may also be moved to coincide with the plane A on which the light forms a shape. Therefore, when the light is sequentially emitted to the whole surface of the measurement target 10, the focal region B is sequentially formed with respect to the whole surface of the measurement target 10.

As an example, a light emitting direction of the light source 130 is moved from one end of the measurement target 10 to the other end so that the light is emitted to the whole surface of the measurement target 10. Accordingly, while the focal region B coincides with the plane A on which the light forms a shape, the focal region B is also moved from the one end of the measurement target 10 to the other end.

The arrangement of the image acquisition means 150 according to an embodiment of the present invention is related to the scheimpflug condition that, when a tilted tangent line extends from an image plane and another tangent line extends from the plane of the lens 140, the plane of focus (POF) also is tangent to a passing line. Under this condition, planar close-up photography is not parallel. Therefore, it is possible to completely focus on the plane A on which the light forms a shape.

The focal region B may completely coincide with the plane A on which the light forms a shape. In this case, even when a three-dimensional shape is estimated by aggregating images taken by the image acquisition means 150, the three-dimensional shape is not distorted, and it is possible to obtain result values which are substantially the same as those of an actual shape.

The image acquisition means 150 according to an embodiment of the present invention may acquire an image of the object and then transfer the acquired image to the control unit 160.

The control unit 160 may calculate a shape or heights of the measurement target 10 by processing the image received from the image acquisition means 150.

The control unit 160 according to an embodiment of the present invention may record a series of images acquired by the image acquisition means 150 in sequence. When the records of these images are calculated, it is possible to align points corresponding to the same physical point on the surface in a series of images.

However, the control unit 160 is not limited thereto and involves any method for calculating the shape or heights of the measurement target 10 by processing the images.

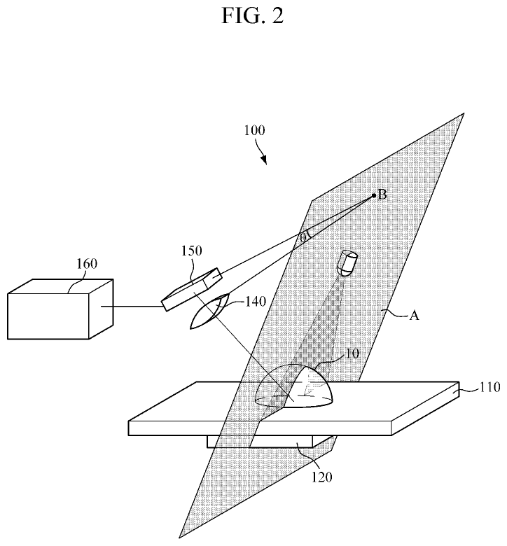

FIG. 2 is a perspective view of an apparatus for measuring a three-dimensional shape according to another embodiment of the present invention. Referring to FIG. 2, a light source 130 may be arranged at a tilt angle with respect to a measurement plane 110 and emit inclined light to a measurement target 10.

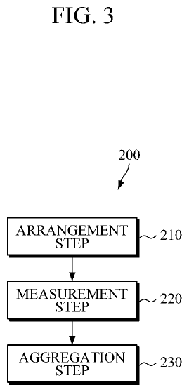

FIG. 3 is a flowchart of a method of measuring a three-dimensional shape using the three-dimensional shape measuring apparatus shown in FIG. 1.

Referring to FIG. 3, a three-dimensional shape measuring method 200 according to an embodiment of the present invention is a method 200 of measuring a three-dimensional shape using an apparatus including a measurement plane 110 on which a measurement target 10 is mounted, a light source 130 which illuminates the measurement target 10, a lens 140 which transmits light emitted from the light source 130, and an image acquisition means 150 which captures an image reflected from a surface of the measurement target 10. According to the method, a focal region B formed by the lens 140 and the image acquisition means 150 is caused to cross the measurement plane 110 at right angles such that the measurement target 10 may be measured.

The three-dimensional shape measuring method 200 according to an embodiment of the present invention includes an arrangement step 210, a measurement step 220, and an aggregation step 230.

In the arrangement step 210, the focal region B formed by the lens 140 and the image acquisition means 150 is arranged to coincide with a plane A on which the light forms a shape. Then, it is prepared to measure a three-dimensional shape.

As an example, a position of the image acquisition means 150 is adjusted such that the focal region B formed by the lens 140 and the image acquisition means 150 may be arranged to coincide with the plane A on which the light forms a shape. In this case, when the plane A on which the light forms a shape is moved with movement of the light source 130, the focal region B is also moved to coincide with the plane A on which the light forms a shape.

In other words, a light emitting direction of the light source 130 is adjusted from one end of the measurement target 10 to the other end so that the light is emitted to the whole surface of the measurement target 10. Accordingly, the image acquisition means 150 is controlled to move the focal region B from the end of the measurement target 10 to the other end such that the focal region B may coincide with the plane A on which the light forms a shape.

In the measurement step 220, light is emitted to the three-dimensional shape through the light source 130, and images are acquired for measurement from light reflected from the three-dimensional shape through the lens 140 and the image acquisition means 150.

In the aggregation step 230, a three-dimensional shape of the measurement target 10 is calculated by aggregating the acquired images.

1. An apparatus for measuring a three-dimensional shape, the apparatus comprising:
a measurement plane on which a measurement target is mounted;
a light source configured to illuminate the measurement target;
a lens configured to transmit light emitted from the light source; and
an image acquisition means configured to capture an image reflected from a surface of the measurement target,
wherein the lens and the image acquisition means are arranged so that a focal region formed by the lens and the image acquisition means coincides with a plane on which the light forms a shape.

2. The apparatus of claim 1, further comprising a driving means configured to move the measurement plane on which the measurement target has been mounted in one direction.

3. A method of measuring a three-dimensional shape using an apparatus including a measurement plane on which a measurement target is mounted, a light source configured to illuminate the measurement target, a lens configured to transmit light emitted from the light source, and an image acquisition means configured to capture an image reflected from a surface of the measurement target, the method comprising causing a focal region formed by the lens and the image acquisition means to coincide with a plane on which the light forms a shape and measuring the measurement target.
